(19) United States
(12) Patent Application Publication
(10) Pub. No.: US 2025/0379675 A1
(43) Pub. Date: Dec. 11, 2025

(54) CENTRALIZED PLATFORM FOR CONTENT AGGREGATION AND SUBSCRIPTION MANAGEMENT

(71) Applicant: DISH Network L.L.C., Englewood, CO (US)

(72) Inventor: Jason Anguiano, Castle Rock, CO (US)

(21) Appl. No.: 19/022,580

(22) Filed: Jan. 15, 2025

Related U.S. Application Data
(60) Provisional application No. 63/656,668, filed on Jun. 6, 2024.

(51) Int. Cl. H04H 60/21; H04N 21/239; H04N 21/258

(52) U.S. Cl. CPC H04H 60/21; H04N 21/2396; H04N 21/25816; H04N 21/25875

(57) ABSTRACT

Devices, systems, and computer-implemented methods for subscription management are provided. An example method includes receiving user information and identifying a plurality of subscriptions and a corresponding plurality of subscribed service provider based on the user information. Each one of the plurality subscriptions is established between the user and the corresponding subscribed service providers. The method further includes obtaining authentication data associated with each one of the plurality of subscribed service provider, obtaining subscription data including subscription cost of each one of the identified subscriptions, presenting simultaneously the subscription data of the identified subscriptions to the user through a user interface of the subscription hub, and linking each one of the plurality of subscribed service providers to the subscription hub.

### CROSS REFERENCE TO RELATED APPLICATIONS

This application claims priority to U.S. Provisional Patent Application No. 63/656,668, filed on Jun. 6, 2024, the disclosure of which is incorporated by reference in its entirety for all purposes.

In today's digital landscape, individuals encounter an increasingly intricate web of media streaming services and digital product subscriptions. This growth in subscriptions has presented challenges not only in managing billing cycles and account administration, but also in content selection and service delivery. Users often grapple with complexities related to multiple subscriptions spread across diverse platforms, leading to issues with separate authentications, usernames, passwords, payment methods, and billing dates. Furthermore, content access is fragmented in decentralized environments, where each platform operates in isolation. This, in turn, compels users to switch between various apps or websites to enjoy their preferred shows, games, or live streams, resulting in a frustrating user experience. Additionally, the process of discovering specific content is time-consuming and often require users to conduct individual searches across multiple platforms.

### SUMMARY

In accordance with some embodiments of the present disclosure, a method is provided. In one example, the method is performed by a computer device and includes: receiving user information from a user in the computer device and identifying a plurality of subscriptions and a corresponding plurality of subscribed service provider based on the user information. Each one of the plurality subscriptions established between the user and the corresponding subscribed service providers. The method further includes obtaining authentication data associated with each one of the plurality of subscribed service provider and obtaining subscription data of each one of the identified subscriptions. The subscription data including subscription cost of the identified subscription. The method further includes presenting simultaneously the subscription data of the identified subscriptions to the user through a user interface of the computer device and linking each one of the plurality of subscriptions and the corresponding subscribed service provider to the computer device.

In accordance with some embodiments of the present disclosure, a subscription hub for subscription management and content aggregation is provided. In one example, the subscription hub is a computer device including one or more processors and a computer-readable storage media storing computer-executable instructions. The computer-executable instructions, when executed by the one or more processors, cause the subscription hub to receive user information in the subscription hub and identify a plurality of subscriptions and a corresponding plurality of subscribed service provider based on the user information. Each one of the plurality subscriptions established between the user and the corresponding subscribed service providers. The instructions, when executed by the one or more processors, further cause the subscription hub to obtain authentication data associated with each one of the plurality of subscribed service provider and obtain subscription data of each one of the identified subscriptions. The subscription data including subscription cost of the identified subscription. The instructions, when executed by the one or more processors, further cause the subscription hub to present simultaneously the subscription data of the identified subscriptions to the user through a user interface of the subscription hub and link each one of the plurality of subscribed service providers to the subscription hub.

In accordance with some embodiments of the present disclosure, a subscription hub for subscription management and content aggregation is provided. In one example, subscription hub includes a user interface, a subscription identification engine, a subscription identification engine, and a subscription management engine. The user interface is configured to receive user information in the subscription hub. The subscription identification engine is configured to identify a plurality of subscriptions and a corresponding plurality of subscribed service provider based on the user information. Each one of the plurality subscriptions established between the user and the corresponding subscribed service providers. The centralized authentication engine is configured to obtain authentication data associated with each one of the plurality of subscribed service provider and perform a centralized authentication process using the authentication data to authenticate the user for accessing the identified plurality of subscriptions. The subscription management engine is configured to obtain subscription data of each one of the identified subscriptions. The subscription data including subscription cost of the identified subscription. The subscription management engine is further configured to link each one of the plurality of subscribed service providers to the subscription hub. The user interface is further configured to present simultaneously the subscription data of the identified subscriptions to the user through the user interface of the subscription hub.

In accordance with some embodiments, the present disclosure also provides a non-transitory machine-readable storage medium encoded with instructions, the instructions executable to cause one or more electronic processors of a computer device or a computer system to perform any one of the methods described in the present disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a schematic diagram illustrating an example of a content distribution system, according to various embodiments.

FIG. 2 is a schematic diagram illustrating an example of a communications system, according to various embodiments.

FIG. 3 is a flow diagram illustrating an example method for subscription management, according to various embodiments.

FIG. 4 is a flow diagram illustrating another example method for subscription management, according to various embodiments.

FIG. 5A is a flow diagram illustrating another example method for subscription management, according to various embodiments.

FIG. 5B is a flow diagram illustrating another example method for subscription management, according to various embodiments.

FIG. 6A is a flow diagram illustrating another example method for subscription management, according to various embodiments.

FIG. 6B is a flow diagram illustrating another example method for subscription management and content aggregation, according to various embodiments.

FIG. 7 is a schematic diagram illustrating an example computer system or computer device, according to various embodiments.

### DETAILED DESCRIPTION

The present disclosure provides methods, devices, systems, and software products generally related to automatic subscription management, content aggregation, and content recommendation.

One insight provided by the present disclosure is related to a single and centralized platform that manages multiple subscriptions of media streaming services and digital products for an individual user. The centralized platform is also referred to as a “subscription management hub” or a “subscription hub” according to the present disclosure. The subscription hub may be a physical piece of hardware, similar to a set-up box, or a software application installed on a user device such as a smart TV. Alternatively, the subscription hub may be cloud-based operating online and is accessible from multiple devices with a network connection (e.g., Internet). The subscription hub may include, among others, one or more of the following components: a user interface, a subscription management engine, a content aggregation engine, a search and discovery engine, an account management engine, a notification and alert engine, an analytics engine, a content recommendation engine. The centralized subscription hub can empower an individual user to efficiently manage various subscriptions and aggregate content in one place. The centralized hub could offer a unified management system for subscriptions, simplified authentication processes, streamlined access to content, and enhanced content aggregation for the benefit of the user. By providing a centralized solution to subscription and content management, users can gain better control over their digital subscriptions and enjoy a more seamless and integrated experience.

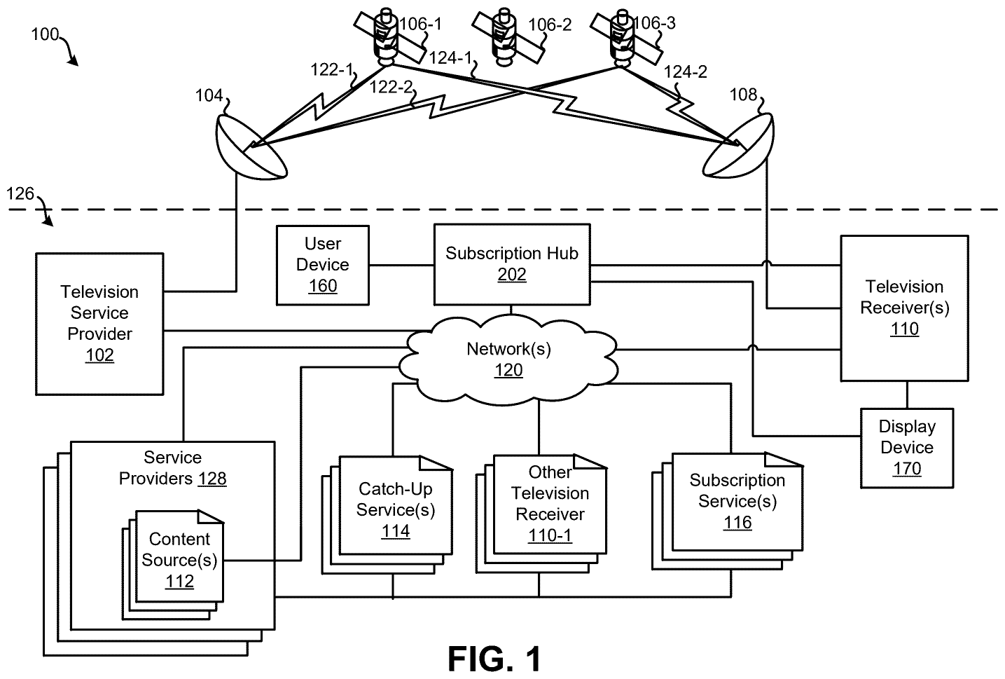

FIG. 1 illustrates an embodiment of a content distribution system 100. For brevity, system 100 is depicted in a simplified and conceptual form, and may generally include more or fewer systems, devices, networks, and/or other components as desired. Further, the number and types of features or elements incorporated within the system 100 may or may not be implementation-specific, and at least some of the aspects of the system 100 may encompass a cable television distribution system, an IPTV (Internet Protocol Television) content distribution system, and/or any other type of media or content distribution system.

The system 100 may include television service provider 102, satellite uplink 104, a plurality of orbiting (e.g., geosynchronous) satellites 106, satellite receiver 108, television receivers 110, one or more contents sources 112 (e.g., online content sources), one or more catch-up services 114, one or more subscription services 116, one or more (other) television receivers 110-1, user devices 160 (e.g., computing devices), and service providers 128 (e.g., online service providers). System 100 further includes a subscription hub 202 configured for managing the subscriptions for an individual user.

System 100 may include one or more networks 120 that can be used for a bi-directional communication path for data transfer with television receivers 110 and other components of system 100. The network 120 is intended to represent any number of terrestrial and/or non-terrestrial networks and/or network features. For example, network 120 may incorporate or exhibit any number of features or elements of various wireless and/or hardwired packet-based communication networks such as, for example, a WAN (Wide Area Network) network (e.g., the Internet), a HAN (Home Area Network) network, a LAN (Local Area Network) network (e.g., a corporate LAN), a WLAN (Wireless Local Area Network) network, a cellular communications network, and/or any other type of communication network(s) configured such that data may be transferred between and among respective elements of the example system 100.

In some embodiments, the networks 120 may include various different communication networks such as an IP network, a satellite network, a cable network, a cellular network, and/or other mobile telecommunication networks. For example, television receiver 110 may support various functionality to establish and connect to backend servers operating at the television service providers 102 via an IP network. Television receiver 110 may transmit various types of data to the backend servers of the television service providers 102, such as orders/requests for television subscription packages, television viewing data, and receiver identification data. In another example, the network 120 may include satellite networks and cable data networks, which may be used in this example for respectively transmitting satellite television data signals and cable television data signals to television receivers 110 and other user equipment. It should be understood that an IP network also may include various components of satellite communication networks and/or or terrestrial cable networks in some embodiments. For communication between user devices 160 and their associated television receivers 110, then communications may include use of a WLAN and/or other short-range wireless technologies. However, for communication between television receivers 130 and remotely located mobile user devices 160 (and/or for user devices 160 that are configured to communicate directly with television service providers 102), then communications may include WANs, satellite networks, terrestrial cable networks, and/or cellular or other mobile telecommunication networks, etc.

The television receivers 110, as described throughout, may generally be any type of television receiver (such as an STB (set-top box), for example) configured to decode signals received for output and presentation via the user device 160. In another example, television receiver 110 (which may include another remote television receiver, such as television receivers 110-1) may be integrated as part of or into a television, a DVR, a computing device, such as a tablet computing device, or any other computing system or device, as well as variations thereof. In some embodiments, a television receiver 110 may be a component that is added into the user device 160, such as in the form of an expansion card. A television receiver 110 and network 120 together with television receivers 110-1, user device 160, and/or other computer system (not shown), may form at least a portion of a particular home computing network, and may each be respectively configured such as to enable communications in accordance with any particular communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-Bandwidth Digital Content Protection), etc.

In some embodiments, broadcast television programs may be delivered to television receivers, including a television receiver 110, via satellite according to a schedule. On-demand content may also be delivered to a television receiver 110 via satellite. Satellites 106 may be configured to receive uplink signals 122 from satellite uplink 104. In this example, uplink signals 122 may contain one or more transponder streams of particular data or content, such as particular television channels, each of which may be supplied by television service provider 102. For example, each of uplink signals 122 may contain various media content such as HD (High Definition) television channels, SD (Standard Definition) television channels, on-demand programming, programming information (e.g., table data), and/or any other content in the form of at least one transponder stream, and in accordance with an allotted carrier frequency and bandwidth. In this example, different media content may be carried using different satellites of satellites 106. Further, different media content may be carried using different transponders of a particular satellite (e.g., satellite 106-1); thus, such media content may be transmitted at different frequencies and/or different frequency ranges. For example, a first and second television channel may be carried on a first carrier frequency over a first transponder (as part of a single transponder stream) of satellite 106-1, and a third, fourth, and fifth television channel may be carried on a second carrier frequency (as part of another transponder stream) over a transponder of satellite 106-3, or, the third, fourth, and fifth television channel may be carried on a second carrier frequency over a second transponder of satellite 106-1, etc.

The satellites 106 may be further configured to relay uplink signals 122 to the satellite receiver 108 as downlink signals 124. Similar to the uplink signals 122, each of the downlink signals 124 may contain one or more transponder streams of particular data or content, such as various encoded and/or at least partially scrambled television channels, on-demand programming, etc., in accordance with an allotted carrier frequency and bandwidth. The satellite receiver 108, which may include a satellite dish, a low noise block (LNB), and/or other components, may be provided for use to receive television channels, such as on a subscription basis, distributed by the television service provider 102 via the satellites 106. For example, the satellite receiver 108 may be configured to receive particular transponder streams as downlink signals 124, from one or more of the satellites 106. Based at least in part on the characteristics of a given television receiver 110 and/or satellite receiver 108, it may only be possible to capture transponder streams from a limited number of transponders of the satellites 106 concurrently. For example, a tuner of the television receiver 110 may only be able to tune to a single transponder stream from a transponder of a single satellite, such as the satellite 106-1, at a time.

The television receiver 110, which may be communicatively coupled to the satellite receiver 108, may subsequently select, via a tuner, decode, and relay television programming to a television for display thereon. Broadcast television programming or content may be presented “live,” or from a recording as previously stored on, by, or at the television receiver 110. For example, an HD channel may be output to a television by the television receiver 110 in accordance with the HDMI/HDCP content protection technologies. Other embodiments are possible. For example, in some embodiments, an HD channel may be output to a television in accordance with the MoCA® (Multimedia over Coax Alliance) home entertainment networking standard. Other embodiments are possible.

The television receiver 110 may select via tuner, decode, and relay particular transponder streams to one or more of television receivers 110-1, which may in turn relay particular transponder streams to display devices 170. For example, the satellite receiver 108 and the television receiver 110 may, respectively, be configured to receive, decode, and relay at least one television channel to a television by way of a television receiver 110-1. Similar to the above example, a television channel may generally be presented “live,” or from a recording as previously stored by the television receiver 110 and may be output to the display device 170 by way of the television receiver 110-1 in accordance with a particular content protection technology and/or networking standard. Other embodiments are possible.

In various embodiments, the content resources 126 may be used to provide the television receiver 110 with a content item (e.g., television program, live stream, media stream, interactive video game, audio stream, recorded content item, or various other types of digital product or service). The content resources 126 may be used to retrieve television programs or portions of television programs following and/or during a live broadcast of the television programs. The content resources 126 may include the television service provider 102, the service providers 128, the online content sources 112, the catch-up services 114, the subscription services 116, and the television receivers 110-1. Other forms of content resources are further detailed below.

The television service provider 102, which may distribute broadcast television programming to the television receivers 110 via a satellite-based television programming distribution arrangement (or some other form of television programming distribution arrangement, such as a cable-based network or IP-based network), may use an alternate communication path, such as via the network 120, to provide television programming to the television receivers 110. The television receivers 110 may be permitted to request various television programs or portions of television programs from the television service provider 102 via the network 120. For instance, the television service provider 102 may be permitted to transmit a portion of a television program or an entire television program during and/or after a time at which the television program was broadcast live by the television service provider via a satellite-based television programming distribution arrangement.

In some embodiments, the television service provider 102 may provide a television program via on-demand content. On-demand content may be included in a user's subscription or may be provided on a per-request basis. Such on-demand content may be provided via the satellite-based distribution arrangement and/or via the network 120. If the on-demand version of the television program requires payment of a fee, before providing the television program to the television receiver 110, a user of the television receiver 110 may at least need to agree to payment of the fee. On-demand content provided via the satellite-based distribution arrangement may be stored locally by the television receiver 110 to allow on-demand access. On-demand content may also be retrieved via the network 120 from the television service provider 102.

The user devices or computing devices 160 represent various computerized devices that may be associated with a user of the television receiver 110 and that may be configured to facilitate various content discovery features disclosed in various embodiments herein. The user devices or computing devices 160 may include a laptop computer, a desktop computer, a home server, or another similar form of computerized device. The user devices or computing devices 160 may also include a cellular phone and/or smartphone, a tablet computer, or another similar form of mobile device. The user devices or computing devices 160 may further include smart glasses or another similar form of wearable computing device. The user devices or computing devices 160 may further include a display device (such as the display device 170) in wired or wireless connection with the television receiver 110 and/or the subscription hub 202 for displaying media streams and contents.

The television receiver 110 may be provided with access credentials that allow access to content or content items stored and/or accessible through one or more of the user devices 160. It should be understood that user devices 160 are exemplary in nature. Content may be accessible through a fewer or greater number of computerized devices associated with a user of the television receiver 110.

In some embodiments, the online content sources 112 may represent content resources through which television programs may be retrieved by the television receiver 110 via the network 120. Television programming available through the online content sources 112 may be available for free and not require subscription (a username and/or password may or may not be necessary). Each of the online content sources 112 may represent different websites available via the Internet. For example, some television programming may be legally made available for free (such as television programming provided by government-funded sources, e.g., the BBC or Hulu®). Periodically, the television receiver 110 may poll online content sources 112 to determine which television programs are available and/or which television programs are scheduled to be available in the future. In some embodiments, the television receiver 110 may poll online content sources 112 regarding the availability of at least a portion of a specific television program.

Additionally or alternatively, the online content sources 112 may represent content resources through which other types of content may be retrieved by the user devices 160 and/or the television receiver 110 via the network 120. For example, content from the online content sources 112 may be pulled by a user device 160 and/or the television receiver 110. The pulled content may correspond to contextual content pertinent to actors recognized in programming content captured by the user devices 160. Such online content sources 112 may include Internet Movie Database (IMDB), Wikipedia, other websites, and/or the like. As another example, the pulled content may correspond to contextual content pertinent to objects (e.g., products) recognized in programming content captured by the user devices 160. Such online content sources 112 may include online retailers, manufacturer websites, other websites, and/or the like.

The catch-up services 114 may represent content resources through which television programs may be retrieved by the television receiver 110 via the network 120. Television programming available through public sources may be available for free and not require subscription (a username and/or password may or may not be necessary). Some catch-up services may require a subscription and may require user authentication. The catch-up services 114 may only make a television program available during the live broadcast of the television program. For example, a catch-up service authorized or run by a television channel (e.g., NBC) or television program production company may make at least a portion of a television program available for streaming or download during a live broadcast scheduled time slot. Therefore, a user may be permitted to watch a missed portion of a live broadcast television program via a catch-up service, but may not be permitted to view the entire television program via the catch-up service at a later time. In some embodiments, television programs may be available via a catch-up service for up to a fixed period of time after the live broadcast of the television program or indefinitely (e.g., until the catch-up service provider decides to remove accessibility to the television program). Periodically, the television receiver 110 may poll the catch-up services 114 to determine which television programs are available and/or which television programs are scheduled to be available in the future. In some embodiments, the television receiver 110 may poll the catch-up services 114 regarding the availability of at least a portion of a specific television program.

The subscription services 116 may represent content resources through which television programs may be retrieved by the television receivers 110 via the network 120. Television programming available through subscription services 116 may require a paid subscription and may require a username and/or password be provided. Each of subscription services 116 may represent different websites available via the Internet. For example, some television programming may be legally made available via a service operated by a television channel or authorized agent of the television channel or television program production company. Periodically, a television receiver 110 may poll subscription services 116 to determine which television programs are available and/or which television programs are scheduled to be available in the future. In some embodiments, the television receiver 110 may poll the subscription services 116 regarding the availability of at least a portion of a specific television program.

The television receiver 110 may be able to retrieve at least a portion of a television program through other television receivers 110-1, which can function as content resources. Similarly, the television receiver 110 may be able to cast at least a portion of a television program through other television receivers and/or to user device 160. For instance, a Slingbox® (or other form of media streaming device) functioning in concert with a television receiver may permit television programs to be captured and streamed over the network 120. In some embodiments, the television receivers 110 may have such media streaming capabilities integrated. In some embodiments, the television receivers 110 may cast programming content to the user devices 160 via wireless signals. For example, the programming content from the television receiver may be indirectly transmitted via a local network (e.g., via Wi-Fi) or directly transmitted to the computing device via a casting device integrated with the television receiver 110 or coupled to the television receiver 110 (e.g., via a dongle). In some embodiments, the programming content may be cast to the user device 160 via a wired connection (e.g., via one or more of HDMI, USB, lightning connector, etc.). Some embodiments of the television receivers 110 may provide for simulcasting such that the same programming that is being played on the user device 160 is being displayed on one or more of a display device 170 simultaneously or substantially simultaneously.

A user may be able to obtain at least a portion of a television program via the television receivers 110, which may be associated with other users or with the same user. For instance, the user may have multiple television receivers at different locations. Periodically, the television receiver 110 may poll the other television receivers 110 to determine which television programs are available and/or which television programs are scheduled to be available in the future. In some embodiments, the television receiver 110 may poll the television receivers 110-1 regarding the availability of at least a portion of a specific television program.

The subscription hub 202 is in communication with the user device 160, television service provider 102, television receivers 110, other television receiver 110-1, service providers 128, catch-up services 114, subscription services 116 via the network 120. In some embodiments, subscription hub 202 is integrated with the television receiver 110 or operating on the television receiver 110. A user can access his or her subscriptions and contents directly through the television receiver 110. In some embodiments, the subscription hub 202 is an independent device operating independently. The standalone subscription hub 202 could be a physical hardware device that connects to the television receiver 110, the user device 160, the display device 170, and other equipment such as personal computer, laptop, tablet, etc., operated by the user. In some embodiments, the subscription hub 202 is cloud-based and operating on a web server. Individual users can access the cloud-based subscription hub 202 via a web interface such as a web portal, making it accessible from various user devices with a network connection. The cloud-based subscription hub 202 may allow for real-time updates and synchronization of subscription and content data. In some embodiments, the subscription hub 202 is in a form of a software installed and operating on the user device 160. The subscription hub application may allow users to manage their subscriptions and access aggregated content directly from the user devices 160 such as smartphones, tablets, or computers.

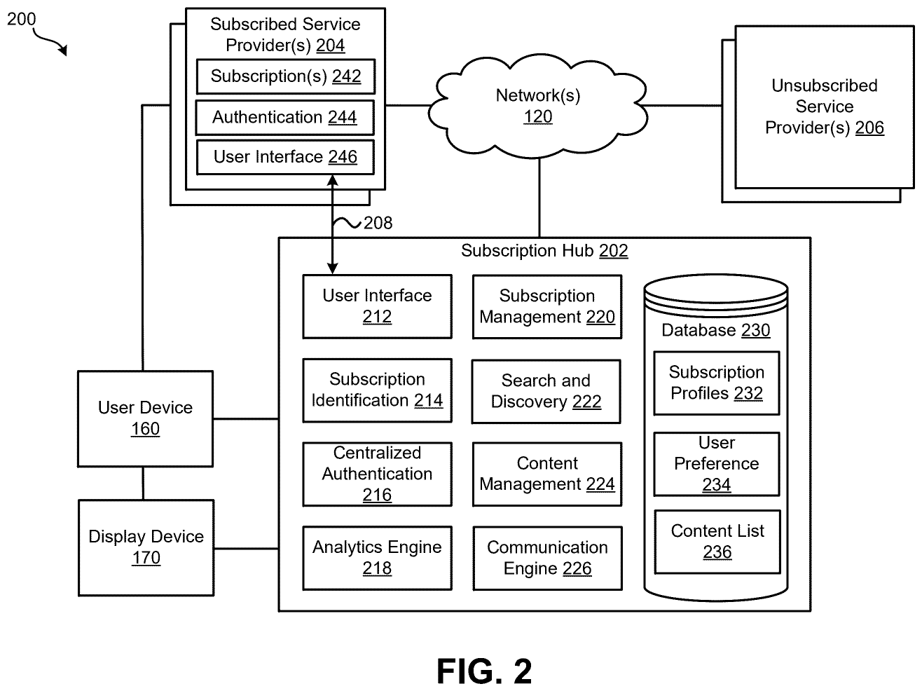

FIG. 2 is a block diagram illustrating a communication system 200 (hereinafter “system 200”), according to various embodiments. In the illustrated example, system 200 includes subscription hub 202, network 120, and multiple service providers (e.g., subscribed service providers 204 and unsubscribed service providers 206). The subscription hub 202 is in communication with the service providers 204 and 206 via the network 120. The service providers 204 and 206 may be one or more of the television service providers 102 and service provider 128 shown in FIG. 1. It is noted that the service providers 204 and 206 can encompass a wide range of services, including television services, game services, content providers, streaming platforms, and more. A user is subscribed to the subscribed service provider 204 and has at least one current subscription service provided by the subscribed service provider 204. The user is not subscribed to the unsubscribed service provider 206.

In some embodiments, the subscription hub 202 includes, among other components, a user interface 212, a subscription identification engine 214, a centralized authentication engine 216, an analytics engine 218, a subscription management engine 220, a search and discovery engine 222, a content management engine 224, a notification engine 226, a communication engine 228, and a database 230. Additional or fewer components may be included in the subscription hub 202. Each component included in the subscription hub may be in a form of a hardware, a software, or a combination of both.

The user interface 212 may include a graphical user interface (GUI) for the user to manage subscriptions, access content, view recommendations, and control their subscription-related activities. The user interface 212 may provide the user with a single, cohesive, centralized, and interactive platform for the user to interact with the subscription hub 202 and use the functionalities provided by the subscription hub 202. In some embodiments, the user interface 212 enables the users to interact with the service providers 204 and 206 via the subscription hub 202.

In some embodiments, user interfaces of the subscribed service providers 204 may be integrated to the user interface 212 of the subscription hub 202 to enable users to access the content and features of the service provider using the user interface 212 of the subscription hub 202. As one example, the subscription hub 202 may have an API (application Programming Interface) integration 208 for connecting a user interface 246 of a subscribed service provider 204 to the user interface 212 of the subscription hub 202. An example process for API integration 208 may include: discovering and identifying the user interface 246 of a subscribed service provider 204, including authentication methods and documentation, accessing the user interface 246 of a subscribed service provider 204 on behalf of the user, accessing various API endpoints for user data, actions, settings, and account management of a user account associated with the subscribed service provider 204, sending requests to the API to retrieve user-specific data, followed by parsing and processing the API responses, creating custom user interface components within the user interface 212 of the subscription hub 202 to display the user data of the subscribed service provider 204. The API integration 208 can enable the user to seamlessly access and interact with the content and functionality of the subscribed service provider 204 through the user interface 212 of the subscription hub 202, which may centralize access to multiple subscribed service providers 204, simplify the user experience, and enhance convenience.

The subscription identification engine 214 is responsible for identifying existing or current subscriptions subscribed by or associated with the user. In some embodiments, the subscription identification engine 214 may receive user input that provides necessary information about the existing subscriptions (e.g., subscription services 242 provided by the service provider 204), including information about the service providers, subscription levels, and the type of services the user has signed up for. In some embodiments, subscription identification engine 214 can connect to APIs (application Programing Interfaces) of the service providers 204 to retrieve detailed information about the user's subscriptions, including subscription status, subscribed content items and services, billing details, and other relevant information. In some embodiments, the subscription identification engine 214 may analyze billing statements from service providers 204 and extract information about the subscriptions. In some embodiments, the subscription identification engine 214 can analyze the user's correspondences with the service provider 204 (e.g., email communications) for information such as digital receipts and billing statements, and extract subscription data from these emails. In some embodiments, the subscription identification engine 214 can scan the user's subscription accounts of the service providers 204 for changes or updates in the existing subscriptions as well as any new subscription. In some embodiments, the subscription identification engine 214 can automatically identify the existing subscriptions. In some embodiments, the subscription identification engine 214 can verify the existing subscriptions with the user through user interaction (e.g., using the user interface 212).

The centralized authentication engine 216 is responsible for establishing a user's master account within the subscription hub 202. The master account can be used to streamline and simplify the user's experience and enable the user to undergo a one-time authentication process to grant the user access to all of the subscription services associated with the user. The subscription services can encompass various digital offerings such as television programs, content items, media streams, video games, digital publications, and other digital products and services. By centralizing authentication, the centralized authentication engine 216 enables the user to seamlessly access his or her subscribed services across all service providers they are subscribed to once a user is authenticated. This eliminates the need for repeated logins and authentication procedures and provides the user a more convenient and unified experience.

In some embodiments, the centralized authentication engine 216 may generate a subscription profile 232 for each subscription service for the user. Each subscription profile 232 corresponds to one service provider and may include, among other components, the user identity (e.g., username) for the corresponding service provider, the user credentials (i.e., password or other types of authentication data) for the corresponding service provider, subscription data (e.g., information on the subscribed content or service, subscription status, billing, payment method, etc.) for the corresponding service provider. These subscription profiles 232 may be stored in the database 230 and timely updated.

The centralized authentication engine 216 may operate by executing an authentication process in response to a user-initiated request for logging into or accessing the master account. The authentication process may further include the identification of subscription profiles associated with each service provider established on the subscription hub 202, the retrieval of user credentials from the subscription profiles, the transmission of authentication requests (including the associated user credentials) respectively to the authentication components 244 of the multiple subscribed service providers 204, and the optional dispatch of user notifications subsequent to the user's successful authentication by the authentication components 244 of the subscribed service providers 204, thereby enhancing the efficiency and convenience of authenticating and gaining access to diverse services linked to the master account.

The analytics engine 218 is responsible for processing user data and subscription data retrieved from each one the multiple subscribed service providers 204 linked to the subscription hub 202, analyzing the content information (e.g., content catalogue) included in the subscription service, and analyzing user viewing history and preferences. In some embodiments, the analytics engine 218 may identify relevant contents of interests from the content catalogues from each one of the multiple subscribed service providers 204 in response to a user request. For example, the user may request information of a content item (e.g., a television channel, a scheduled live stream, a video game, a broadcast event, a movie, or other types of media streaming services), and the analytics engine 218 in response may perform a search and identify the relevant content items available and accessible from the subscribed service providers 204 linked to the subscription hub 202.

The analytics engine 218 may be responsible for detecting redundancy among subscriptions linked to the subscription hub 202 for optimization of the user's access to content while minimizing duplicative subscriptions. In some embodiments, the analytics engine 218 may retrieve comprehensive user data and subscription data regarding the multiple subscribed service providers 204 linked to the subscription hub 202. As mentioned above, the user data and subscription data include information about the subscription services, available content, pricing, user preferences, and subscription history. The analytics engine 218 can automatically conduct an analysis of the content catalogues of the subscribed service providers 204. The analysis may include an examination of the content items available within each subscription service, such as television channels, scheduled live streams, video games, broadcast events, movies, and other media streaming service offerings. The analytics engine 218 may take into account user viewing history and preferences to ascertain the content that has been historically favored by the user in the assessment of redundancy. Based on the content catalog analysis and user preference assessment, the analytics engine 218 may identify overlapping or redundant content items across the subscribed service providers 281. Redundancy may be determined by comparing the offerings of different subscription services and recognizing content items that substantially overlap in terms of genre, availability, and user interest. In some embodiments, the analytics engine 218 can further refine the redundancy detection and quantify the degree of overlap between subscription services, taking into account factors such as the number of common content items and the extent of user engagement with these items. Subsequent to detecting redundancy, the analytics engine 218 may generate user-specific recommendations. The recommendations may suggest optimizing the user's subscription portfolio by eliminating redundant services while maintaining access to preferred content. The analytics engine 218 may also generate and send notifications or alerts to the user, presenting the identified redundancies and the recommended actions to address them. Following the user notification, the analytics engine 218 may awaits user confirmation or adjustments based on the recommendations. The subscription hub 202 may provide the user with options to choose to accept the recommendations or make alternative selections to tailor their subscription portfolio to their specific preferences and cost considerations.

The analytics engine 218 may be responsible for prioritizing the existing subscriptions based on subscription cost, content of interest, and other factors. For example, the analytics engine 218 may group similar existing subscription services (e.g., subscription services with a common or similar content characteristics such as movie genre, sport, show, etc.), assess subscription cost for each subscriptions service, prioritize/rank the subscription services based on the cost of each subscription services, user-specific content preferences, as determined by viewing history and ratings, as well as other factors, generate a prioritization list, and present the prioritization list to the user. The user can interact with the prioritization list and potentially adjust subscriptions.

The subscription management engine 220 is responsible for automatically managing existing subscriptions and establishing new subscriptions with authorization and/or direction by the user. In some embodiments, once a redundancy is detected and an authorization to terminate the redundant subscription from the user is obtained, the subscription management engine 220 can automatically suspend or terminate the redundant subscription (i.e., performing a de-subscription) for the user. The subscription management engine 220 can proceed to initiate the suspension or termination of the redundant subscription and communicate with the subscribed service provider 204 associated with the redundant subscription to execute the suspension or termination. Upon successful suspension or termination of the redundant subscription, the subscription management engine 220 can confirm the action and issues a notification to the user. The notification may include details of the suspended terminated subscription, such as the date of termination and any resulting changes in subscription costs.

In some embodiments, the subscription management engine 220 continuously monitors the subscribed services for any changes or updates, including but not limited to alterations in pricing, changes in available content, and adjustments to subscription durations. Upon detecting a change within a subscribed service, the subscription management engine 220 may identify the nature of the change, whether it pertains to pricing, content scope, or subscription duration. In response to the detected change, the subscription management engine 220 may generate a timely notification and communicates this notification to the user through the user interface 212. The notification may contain information about the specific change or update, including details such as the nature of the change, the effective date, and any potential impact on the user's subscription experience. The notification may also provide the user with options or actions the user can take in response to the change, such as confirming acceptance of the change, canceling the subscription, or adjusting their subscription preferences. Upon user's authorization, the subscription management engine 220 may proceed to take any action decided by the user. The subscription management engine 220 may maintain a record of notifications sent to the user, user responses, and any actions taken to address subscription changes.

In some embodiments, the subscription management engine 220 may automatically analyze the cost or fees associated with making changes or modifications to a subscription. For example, the subscription management engine 220 may retrieve and examine the user's subscription agreement with the subscribed service provider 204 and perform analysis of the terms and conditions included in the agreement. The subscription management engine 220 may identify and extract clauses or stipulations within the subscription agreement that delineate the cost or fees linked to making changes or modifications to the subscription. These clauses may include charges related to alterations in subscription tiers, services, or billing cycles. The subscription management engine 220 may proceed to evaluate the financial implications of the identified change or modification costs and fees and generate analytical results including information regarding the presence of change or modification costs, the conditions under which they apply, and the estimated financial consequences of subscription change. The subscription management engine 220 may present the analytical results to the user through the user interface 212 of the subscription hub 202. The user is provided with the knowledge to make informed decisions about their subscriptions. The subscription management engine 220 may await authorization from the user before proceeding with any subscription changes that may incur fees or costs. In some embodiments, the subscription management engine 220 may provide the user with options through the user interface 212, including choosing to proceed with subscription changes, postponing changes to minimize costs, or exploring alternative actions to achieve the user's subscription preferences.

In some embodiments, the subscription management engine 220 may employ mechanisms to handle inactive subscriptions. For example, the subscription management engine 220 may continually monitor the activity of subscriptions within the subscription hub 202 and keep track of each subscription's usage and interactions. The subscription management engine 220 may identify subscriptions that have remained inactive for a predetermined time period, such as a month, without any user interactions or usage. Upon detecting an inactive subscription, the subscription management engine 220 initiates a notification process by sending a notification to the user, indicating that the subscription has been inactive for the specified time frame and transmits the notification to the user through the user interface 212. The subscription management engine 220 may provide the user with an option to take actions in response to the notification. The user may choose to reactivate the subscription, indicating their continued interest, or choose to opt to maintain the subscription in its inactive state. In cases where the subscription management engine 220 does not receive a user request to maintain or reactivate the subscription, and the subscription continues to remain inactive beyond the predetermined time period, the subscription management engine 220 may initiate an automatic de-subscription process. This de-subscription process may involve the removal of the inactive subscription from the user's list of managed subscriptions. If the user receives the initial notification but does not wish to continue the subscription, the user can choose to acknowledge the notification, indicating his or her intention to allow the subscription to be automatically de-subscribed. Once the de-subscription process is triggered, the subscription management engine 220 may confirm the removal of the inactive subscription and inform the user of this action through a separate notification.

The search and discovery engine 222 allows the user to perform a search of a content item of interests. In some embodiments, the search and discovery engine 222 may automatically search and identify a content item or a service of interest in response to a user input or request. For example, the user may send a request for a content of interest through the user interface 212. In response, the search and discovery engine 222 can perform an internal search and determine presence or absence of the requested content item within the existing subscriptions linked to the subscription hub 202. In response to a determination that the requested content item is absent, the search and discovery engine 222 may perform an external search to identify a source of the content item not linked to the subscription hub 202. The source may be an unsubscribed service provider 206. The search and discovery engine 222 may further identify the unsubscribed service provider 206 that provides the requested content item, determine the cost of the content item, and notify the user the source of the requested content item.

In another example, the search and discovery engine 222 can perform an internal search and determine presence the requested content item within the existing subscriptions linked to the subscription hub 202. The search and discovery engine 222 can further perform an external search to identify one or more unsubscribed service providers 206 that provide the requested content item. The search and discovery engine 222 can determine the subscription cost of the unsubscribed service providers 206 compare the subscription cost of the unsubscribed service providers 206 with the subscription cost of the subscribed service providers 204. In response to a determination that the subscription cost of the unsubscribed service providers 206 is less than the subscription cost of the subscribed service providers 204 (or a difference between the subscription cost of the unsubscribed service providers 206 and the subscription cost of the subscribed service providers 204 is more than a predetermined threshold set up by the user), the search and discovery engine 222 can notify the user of the unsubscribed service providers 206, and provide the user an option to switch from the subscribed service providers 204 to the unsubscribed service providers 206 for accessing the requested content item.

The content management engine 224 may further include a content aggregation module (content aggregator) and a content recommendation module. In some embodiments, the content aggregator can employ mechanisms for optimizing content aggregation, particularly for multi-season series. For example, the content aggregator can aggregate different seasons of a series, irrespective of the series title, from various subscriptions within the subscription hub 202, such that each season is sourced from the subscription with the lowest cost.

In some embodiments, the user may select a multi-season series through the user interface 212 of the subscription hub 202. This series may comprise multiple seasons. The content aggregator may operate in collaboration with other components such as the analytics engine 218 to perform an internal search to identify individual seasons within the available subscriptions in the subscription hub 202. For each season, the content aggregator may evaluate the subscription cost associated with accessing that season from the respective subscription. The content aggregator may systematically determine which subscription provides the lowest cost for each season, which may further include comparing the subscription fees for the identified seasons within different subscriptions. The content aggregator may aggregate each season from the subscription determined to have the lowest cost, such that each season of the selected series is sourced from the subscription offering the most cost-effective access. The content aggregator may present the series of content items, each representing a season of the selected series, to the user through the user interface 212. Each season is linked to the subscription with the lowest cost. The content aggregator may further provide the user with options to select content items for individual seasons based on their preferences, including cost-effectiveness, subscription terms, and quality. Following the user's selections, the chosen seasons are accessible for viewing from their respective subscriptions, each optimized for the lowest cost.

In alternative embodiments, the content aggregator may operate in collaboration with other components such as the analytics engine 218 and the search and discovery engine 222 to perform an internal search to identify individual seasons within the available subscriptions in the subscription hub 202. For each season, the content aggregator may evaluate the subscription cost associated with accessing that season from the respective subscription. The content aggregator may systematically determine which subscription provides the lowest cost for each season, which may further include comparing the subscription fees for the identified seasons within different subscriptions. In response to a determination that certain seasons are not be available within the internal subscriptions, the content aggregator may initiate an external search to extend beyond the subscriptions managed within the subscription hub 202 and identify external sources (e.g., unsubscribed service providers 206) that provide the missing seasons. The content aggregator may gather information on the external sources, including content availability, pricing, rental options, and access terms for the missing seasons. For each missing season, the content aggregator may identify the external source with the most cost-effective access, considering factors such as subscription fees and content quality. The content aggregator may aggregate each season, including those sourced from the internal subscriptions and the selected external sources, to generate a series with both internal and external content items. The content aggregator may present the complete series of content items, each representing a season of the selected series, to the user through the user interface 212. The subscription management engine 220 may further provide the user with options to subscribe to the external source for the season. In response to a user request for subscribing to the external source, the subscription management engine 220 may automatically subscribe to the external source.

The content recommendation module of the content management engine 224 may operate to generate a list of recommended content items (i.e., the recommended content list or content list 236), based on the user preference profile 234. The content list may be stored in the database 230 and presented to the user through the user interface 212. The content recommendation module can implement a process for tracking the user's viewing history and preferences to automatically generate a recommendation list. The content list may include target content items or target series of content items that are tailored to the user's interests, reflecting their past interactions with digital media. In one example, the content recommendation module consistently tracks the user's viewing history, monitor the user's content preferences, and maintain an up-to-date user preference profile containing user viewing history and preference data. The content recommendation module can analyze the user viewing history and preference data and extract user interest, including but not limited to genres, content types, content duration, and specific content titles that the user frequently engages with or expresses a preference for. The content recommendation module can operate in collaboration with the analytics engine 218 or other components to further map user interests to available content items within the subscription of the subscription hub 202. The content recommendation module can further operate in collaboration with the search and discovery engine 222 to perform an external search to identify a target content item from an external source.

The content list may further include subscription information corresponding to each target content item or target series. The subscription information may include the subscription type data, provider data (existing subscription within the subscription hub 202 or external source not associated with the subscription hub 202), subscription cost, essential subscription terms, access restrictions, among others. The content recommendation module may present the content list to the user and provide the user with options to take action on the content list. In response to a user request, the subscription hub 202 can initiate playback of a selected content item or series directly from the content list, save content items or series of interest to a personalized watchlist, subscribe the identified content item from the external source (e.g., an unsubscribed service provider), and/or perform other operations according to user instructions. Users can also provide feedback regarding the recommended content items or series. The content recommendation module may analyze the user feedback and improve future recommendations.

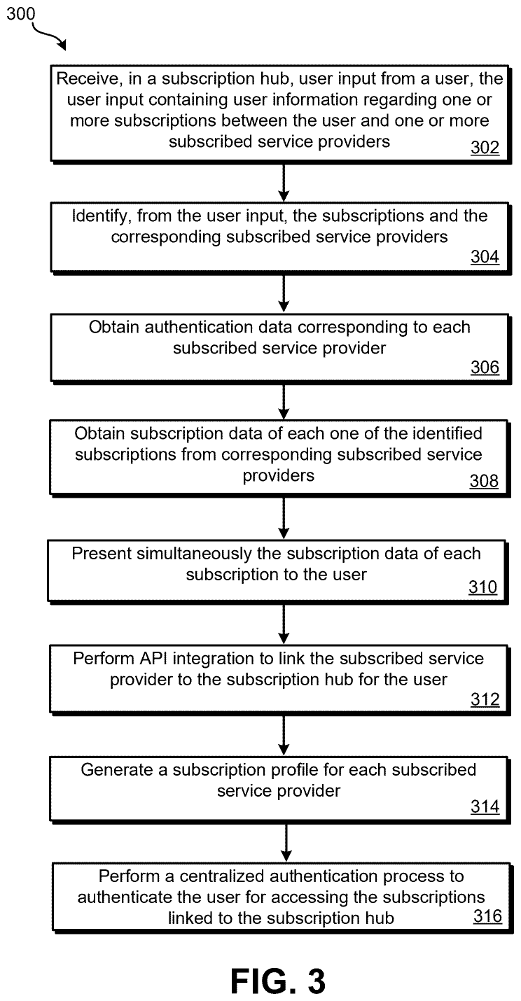

FIG. 3 is a flow diagram illustrating an example method 300 for subscription management according to various embodiments. Method 300 may be performed by the example subscription hub 202 illustrated in FIGS. 1-2. Depending on the implementation, method 300 may include additional, fewer, or alternative steps/operations performed in various orders or in parallel. Method 300 or any steps/operations thereof may be combined with other methods or processes described herein in any suitable manner.

At 302, a user input from a user is received in the subscription hub. The user input contains user information regarding one or more subscription between the user and one or more subscribed service providers. In some embodiments, the user input may be provided by the user, for example, through a user interface of the subscription hub. In some embodiments, a source of the subscription information may be provided by the user to the subscription hub, and the source is analyzed by the subscription hub to extract subscription information from the source.

At 304, the subscriptions between the user and the corresponding subscribed service providers are identified, based on the subscription information from the user input. In some embodiments, a plurality of subscriptions subscribed by the user, each corresponding to a distinct subscribed service provider that provides one or more the subscriptions. In some embodiments, a subscription account for accessing the corresponding subscribed service provider preestablished by the user is also identified.

At 306, authentication data associated with the user for accessing the subscription is obtained by and received in the subscription hub. In some embodiments, the authentication data is provided by the user to the subscription hub through the user interface. In some embodiments, authorization to access the identified subscription account is obtained by the subscription hub from the user.

At 308, subscription data associated with each identified subscription is retrieved from the corresponding subscription account or the corresponding subscribed service provider. The subscription data may include information about the subscription services, available content, pricing, user preferences, and subscription history for each subscription.

At 310, the subscription data of each identified subscription are simultaneously presented to the user, for example, through the user interface to provide the user a comprehensive list of active subscriptions. Users can access detailed information about each subscription, including costs, terms, and available content, by interacting with the presented subscription data.

At 312, the subscription account or the corresponding subscriber service provider is linked to the subscription hub for the user. In some embodiments, an API integration process is performed to integrate the user interface of the subscribed service provider to the user interface of the subscription hub. In some embodiments, the API integration process further includes authenticating the user with the subscribed service provider to obtain access to the user's subscription account, establishing a connection between the subscription hub and the subscribed service provider, generating a data model in the subscription hub, retrieving subscription data from the subscription account, mapping subscription data from the service provider to the subscription hub's data model, performing real-time synchronization to reflect updates in the subscription account, integrating the user interface of the subscribed service provider with the subscription hub, and granting user control over linked subscription accounts, including linking, unlinking, and access management. After the identified subscription account is linked to the subscription hub, the user can access the subscription account directly from the subscription hub once authenticated.

At 314, a subscription profile is generated for each subscribed service provider. Each subscription profile may include a user identity, user credentials, subscription data, subscription cost, etc., for the corresponding subscribed service provider.

At 316, a centralized authentication process is executed to authenticate the user and allow the authenticated user to access the subscriptions linked to the subscription hub. The authentication process may be performed simultaneously or at approximately the same time for all linked subscriptions to streamline the user experience. In some embodiments, the centralized authentication process may further includes receiving authentication requests from multiple subscribed service providers, automatically identifying a subscription profile corresponding to each subscribed service provider, retrieving user credentials from the subscription profile, sending the user credentials respectively to the subscribed service providers, and upon successful authentication, notifying the user.

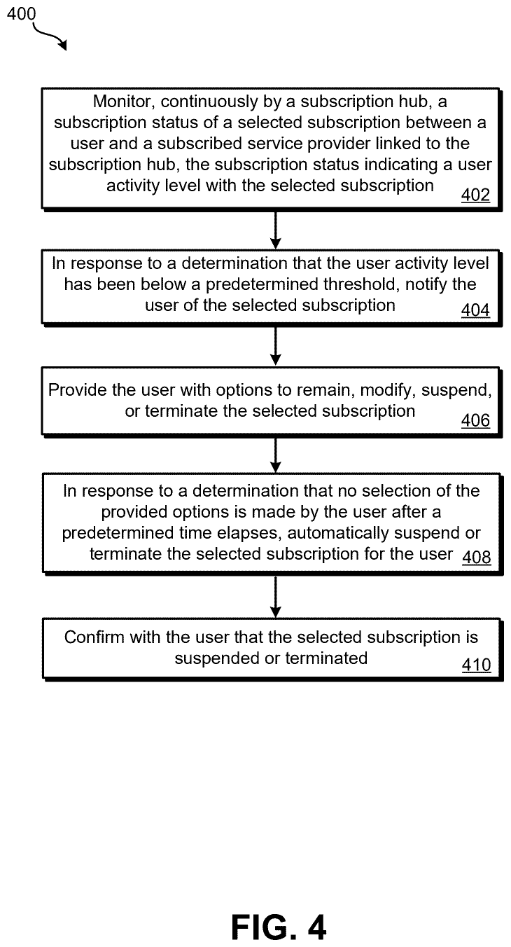

FIG. 4 is a flow diagram illustrating another example method 400 for subscription management according to various embodiments. Depending on the implementation, method 400 may include additional, fewer, or alternative steps/operations performed in various orders or in parallel. Method 400 or any steps/operations thereof may be combined with other methods or processes described herein in any suitable manner.

At 402, a subscription established between a user and a subscribed service provider linked to a subscription hub is selected and monitored continuously by a subscription hub to determine a subscription status of the selected subscription. The subscription status indicates a user activity level with the selected subscription. The user activity level is a quantitative or semi-quantitative measure of the user engagement with the selected subscription. The continuous monitoring process allows the subscription hub to track and evaluate the user's interaction and behavior with the selected subscription over time.

At 404, in response to a determination that the user activity level has been below a predetermined threshold (e.g., a frequency of viewing activity is below a predetermined threshold frequency for a predetermined time period), the user is notified of the selected subscription and the user activity level. The predetermined threshold may be determined or defined based on the user viewing history and other user interaction behavior. A notification may be generated and provided to the user through the user interface of the subscription hub to alert the user to the potential decline in the engagement with the selected subscription.

At 406, options to remain, modify, suspend, or terminate the selected subscription are provided to the user through the user interface. Upon receipt a user selection from the one or more provided options, an action aligned with the user selection is automatically taken by the subscription hub.

At 408, in response to a determination that no selection of the provided options is made by the user after a predetermined time elapses, the selected subscription is automatically suspended or terminated by the subscription hub for the user.

At 410, a confirmation regarding the suspension or termination of the selected subscription is presented to the user, for example, through the user interface of the subscription hub. This confirmation serves to inform the user about the status change of the subscription. In some embodiments, an option for reactivating the suspended or terminated subscription is provided to the user.

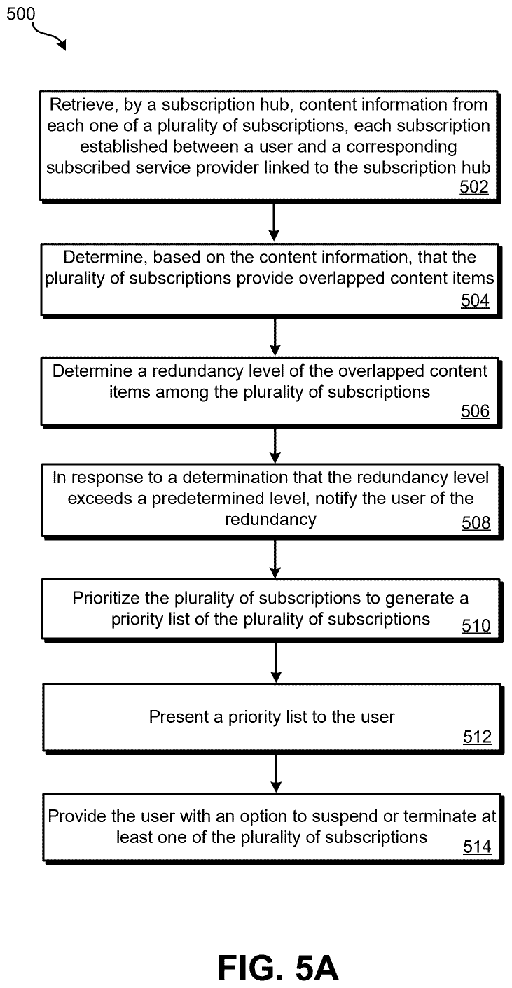

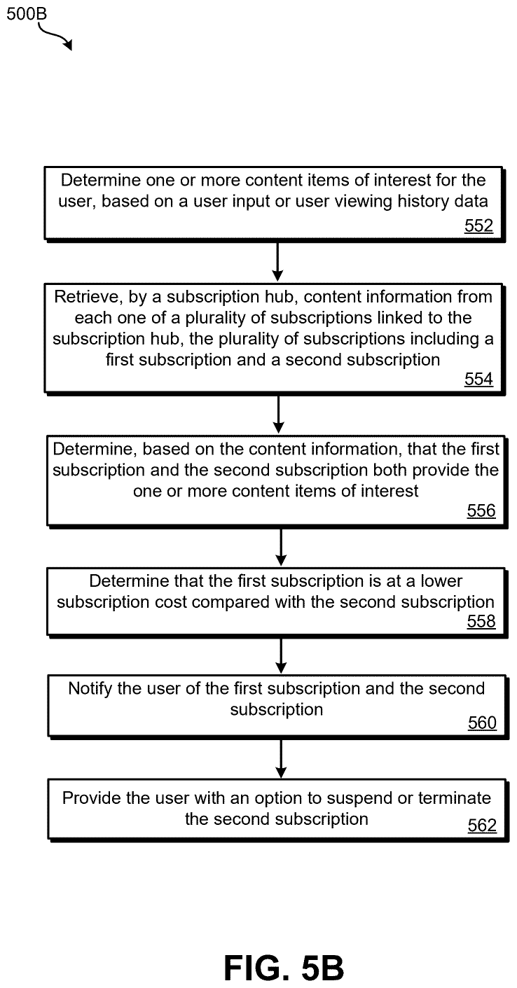

FIG. 5A is a flow diagram illustrating another example method 500A for subscription management according to various embodiments. Depending on the implementation, method 500A may include additional, fewer, or alternative steps/operations performed in various orders or in parallel. Method 500A or any steps/operations thereof may be combined with other methods or processes described herein in any suitable manner.

At 502, content information is retrieved, by a subscription hub, from each one of a plurality of subscriptions linked to the subscription hub. The content information may be retrieved from a content catalogue of the subscribed service provider. The content catalogue may include available and accessible content items subscribed by the user. The content information may include content titles, descriptions, genres, release dates, durations, cast and crew details, user or critic ratings and reviews, thumbnail images, pricing or subscription costs, availability dates, playback options, parental guidance ratings, content language specifications, etc., of the content items included in the content catalogue.

At 504, a determination is made, based on the content information, that the plurality of subscriptions provides content items with overlaps or duplicates. At 506, a redundancy level of the overlapped content items among the plurality of subscriptions is determined. The redundancy level quantifies the extent to which the same or similar content items are accessible through multiple linked subscriptions. In some embodiments, determination of redundancy among the plurality of subscriptions further includes assessing the similarity of content items based on criteria such as content title, genre, description, and other relevant attributes, comparing the content information to establish content items with a significant degree of overlap, assigning a confidence level or score to each identified overlapping content item, indicative of the extent of redundancy, determining a threshold value, based on user preferences or preestablished criteria, that signifies when content redundancy is significant, identifying content items that exceeds the determined threshold for content redundancy, and calculating the redundancy level by summing the confidence levels of identified overlapping content items.

At 508, in response to a determination that the redundancy level exceeds a predetermined level, notify the user of the redundancy. The determined redundancy level as well as the identified content items contributing to the redundancy level are presented to the user through the user interface of the subscription hub.

At 510, the plurality of subscriptions is prioritized to generate a priority list of the plurality of subscriptions. The prioritization process takes into consideration multiple factors, including the subscription cost, content relevance, and the redundancy level of overlapping content items among the linked subscriptions. For example, the subscriptions having redundant or duplicated content items with higher subscription cost may be ranked lower on the priority list.

At 512, the priority list is presented to the user, for example, through the user interface of the subscription hub. The priority list ranks subscriptions with lower redundancy and cost of redundant content items higher.

At 514, an option to suspend or terminate at least one of the plurality of subscriptions that holds a low position on the generated priority list is provided to the user. In response to the user's adoption of the suspension or termination option, one or more actions may be taken by the subscription hub, such as suspending the selected subscription, initiating the termination process, and notifying the user of the actions taken. Statuses of suspended or terminated subscriptions may be monitored by the subscription hub, and the priority list may be updated and presented to the user through the user interface.

FIG. 5B is a flow diagram illustrating another example method 500B for subscription management according to various embodiments. Depending on the implementation, method 500B may include additional, fewer, or alternative steps/operations performed in various orders or in parallel. Method 500B or any steps/operations thereof may be combined with other methods or processes described herein in any suitable manner.

At 552, one or more content items of interest for the user is determined by the subscription hub, based on a user input from the user or the user viewing history data obtained by the subscription hub. At 554, content information is retrieved by a subscription hub from each one of a plurality of subscriptions linked to the subscription hub. The plurality of subscriptions includes a first subscription and a second subscription. At 556, a determination is made, based on the content information, that the first subscription and the second subscription both provide the one or more content items of interest. At 558, a determination is made that the first subscription has a lower subscription cost compared with the second subscription. At 560, a notification is generated and sent to the user. The notification indicates that the first subscription and second subscription provide duplicated content items of interest. At 562, an option is provided to the user to suspend or terminate the second subscription. In response to the user's adoption of the suspension or termination option, one or more actions may be taken by the subscription hub, such as suspending the selected subscription, initiating the termination process, and notifying the user of the actions taken.

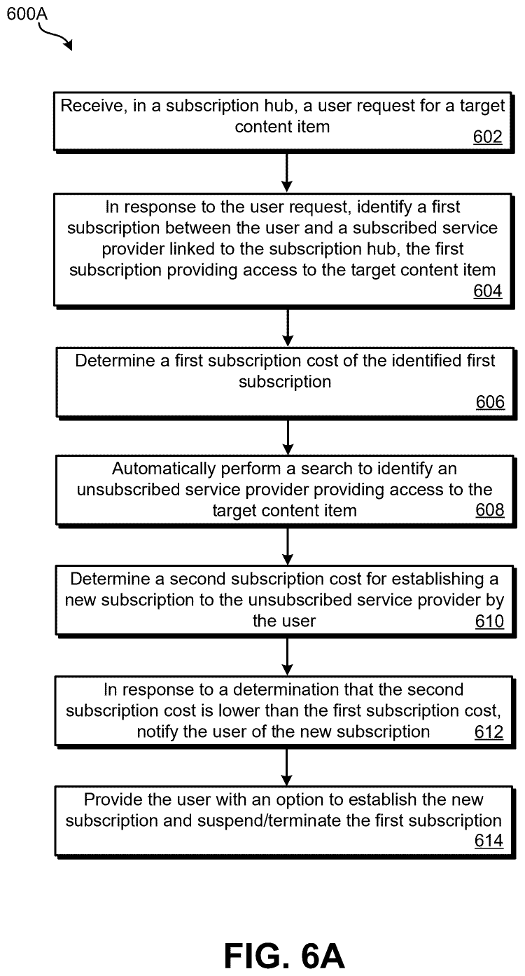

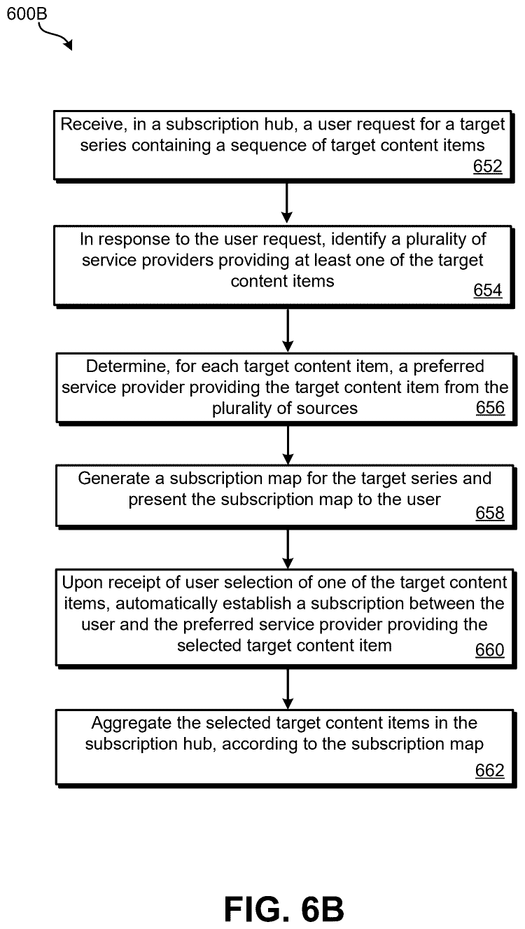

FIG. 6A is a flow diagram illustrating another example method 600A for subscription management according to various embodiments. Depending on the implementation, method 600A may include additional, fewer, or alternative steps/operations performed in various orders or in parallel. Method 600A or any steps/operations thereof may be combined with other methods or processes described herein in any suitable manner.

At 602, a user request for a target content item of interest is received in a subscription hub, for example, through the user interface of the subscription hub. At 604, in response to the user request, a first subscription linked to the subscription hub and providing the target content item is identified from a plurality of subscriptions linked to the subscription hub. At 606, a first subscription cost of the identified first subscription is determined, for example, by locating the subscription profile associated with the first subscription and retrieving relevant content information from the located subscription profile. At 608, a search is automatically performed by the subscription hub to identify an unsubscribed service provider providing access to the target content item. The unsubscribed service provider is not subscribed by the user and is not linked to the subscription hub. At 610, a second subscription cost for establishing a new subscription to the unsubscribed service provider by the user is determined. At 612, a comparison is performed between the first subscription cost and the second subscription cost. In response to a determination that the second subscription cost is lower than the first subscription cost, a notification is generated and sent to the user through the user interface of the subscription hub. The notification indicates that the comparison result. At 614, the user is provided with an option to establish the new subscription and/or suspend or terminate the first subscription. In response to the user's adoption of the option, one or more actions may be taken by the subscription hub, such as establishing the new subscription, suspending the first subscription, initiating a process to terminate the first subscription, and notifying the user of the actions taken.

FIG. 6B is a flow diagram illustrating another example method 600A for subscription management and content aggregation, according to various embodiments. Depending on the implementation, method 600B may include additional, fewer, or alternative steps/operations performed in various orders or in parallel. Method 600B or any steps/operations thereof may be combined with other methods or processes described herein in any suitable manner.

At 652, a user request for a target series is received in a subscription hub. The target series contains a sequence of target content items. Examples of a series includes a television program series such as episodic shows including multiple seasons, a podcast series including a sequence of related audio episodes, a video game series including a collection of video games within the same fictional universe, a sport series including a sequence of sports events, such as a tournament or championship, a movie/film series including a collection of movies that share common characters, settings, or storylines, an opera series including a sequence of operatic performances that are linked by a composer, theme, or era.

At 654, in response to the user request, a plurality of service providers providing at least one of the target content items are identified. The service provider may be a subscribed service provider linked to the subscription hub or an unsubscribed service provider not subscribed by the user and not linked to the subscription hub.

At 656, a preferred service provider from the plurality of identified service providers is determined, by the subscription hub, for each one of the target content items. In some embodiments, attributes of each identified service provider are assessed, taking into account factors such as service quality, availability, cost, and user preferences, in determining the preferred service provider for each of the individual target content items within the series. For example, the service quality may include streaming quality, reliability, and user experience, the subscription cost associated with each service provider may include subscription fees, pay-per-view rates, or any additional charges. The user preference profile and historical user behavior data may also be considered in the determination of the preferred service provider for each of the individual target content items.

At 658, a subscription map is generated for the target series and presented to the user, for example, through the user interface of the subscription hub. An example subscription map includes information about the target series such as series title, description, and the total number of content items within the series. The subscription may further include a list of individual content items within the series, information about the service providers that offer access to content items in the series, including their names, subscription costs, streaming quality, geographic availability, user ratings, user reviews, etc., and a mapping of preferred service providers for each one of the individual content items within the series. The subscription map may further include a section presenting the user with various options related to the series, including actions such as subscribing, adding to a watchlist, or other user-selected choices. The subscription map may further include a summary of the total cost associated with the selected subscriptions for the series. The subscription may further include interactive tools (through the user interface of the subscription hub) to enable the user to compare subscription providers side by side, including features, costs, and available content.

At 660, upon receipt of the user selection of one of the target content items from the subscription map, automatically establish a subscription between the user and the preferred service provider providing the selected target content item. At 662, the selected target content items are aggregated in the subscription hub, according to the subscription map. In some embodiments, upon the user's selection of target content items from the subscription map, each selected target content item is mapped to the corresponding preferred service provider within the subscription map. Content information for the target content items, such as titles, descriptions, release dates, and access details, is aggregated and stored within the subscription hub. Based on the content information of the selected target content items, a personalized playlist or watchlist that includes the selected content items may be generated and presented to the user. The availability of the selected target content items may be monitored continuously to update the status thereof.

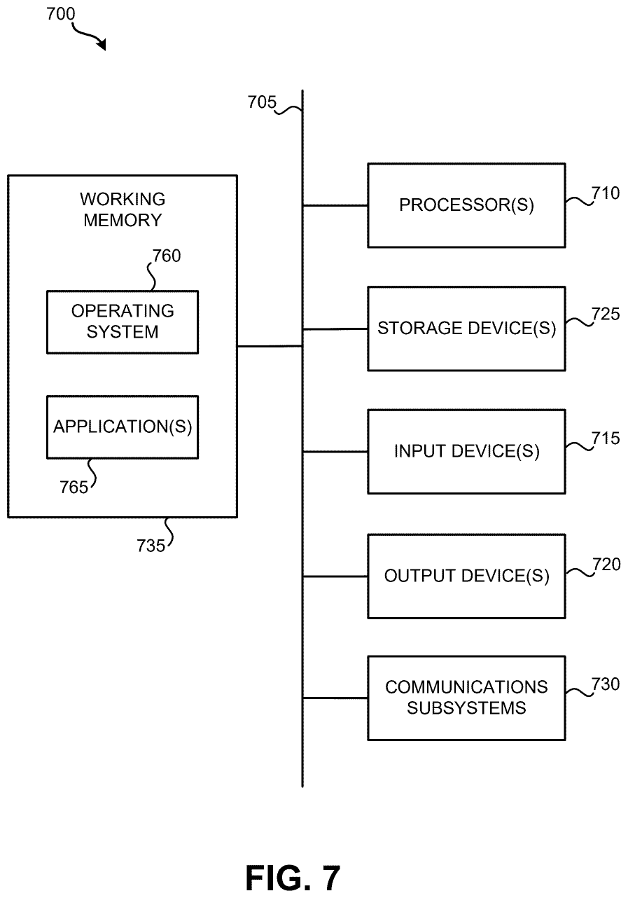

The systems 100, 200, and any components included therein such as the subscription hub 202, the television receiver 110, the service providers 128, the user device 160, as described above may include a computer system that further includes computer hardware and software that form special-purpose network circuitry to implement various embodiments such as communication, data processing, analysis, optimization, calculation, identification, determination, and so on. FIG. 7 is a schematic diagram illustrating an example of computer system 700. The computer system 700 is a simplified computer system that can be used to implement various embodiments described and illustrated herein. A computer system 700 as illustrated in FIG. 7 may be incorporated into devices such as a portable electronic device, mobile phone, server grade machines, or other device as described herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, solid state drive, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a content item” may include a plurality of such content items, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

As used herein, a “subscription” or a “subscription service” refers to an agreement between a user and a service provider facilitated through a digital platform. The agreement grants the user access to specific content, features, or services for a predefined period, in exchange for periodic payments. Subscriptions can encompass a wide range of digital offerings, such as streaming media, software, video game, digital publication, and more, and may include various subscription types (e.g., premium, basic, ad-supported) and associated terms, costs, and access restrictions. The subscription used in the present disclosure also encompasses a pay-to-go content item (e.g., an on-demand television program) or any content items that require payment for access.

As used herein, a “content item” or any equivalent thereof refers to a discrete and self-contained unit of digital media, data, or information that can be delivered and accessed through a digital platform or delivery system. The content items can encompass a wide range of forms, including but not limited to text, images, audio, video, software applications, documents, and interactive media. Content items can be consumed or interacted with by users and can vary in scale from individual articles, images, or songs to larger entities like books, movies, TV episodes, and software programs. Content items may have associated metadata and attributes that provide context, such as titles, descriptions, genres, creators, and more.

As used herein, a “series” or any equivalent thereof refers to a collection of related content items, episodes, or installments that are presented in a sequential or episodic manner, often following a common narrative, theme, or set of characters. The series may be used in various digital media, including television programs, shows, web series, video games, books, and streaming platforms. Series are structured to engage audiences over multiple iterations, with each installment contributing to a broader storyline or theme. Digital media series may comprise seasons, episodes, chapters, or volumes.

As used herein, a “linked subscription” or a “linked subscribed service provider” refers to an active and authenticated connection between a user's subscribed service provider account and a subscription hub of the user. This connection enables real-time synchronization, data exchange, and integrated management of the user's subscribed services within the subscription hub. A linked subscription allows users to access, monitor, and manage their subscribed content, preferences, and status from a user interface of the subscription server to automatically control the subscribed content services.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method performed by a computer device, the method comprising:
receiving, in the computer device, user information from a user;
identifying a plurality of subscriptions and a corresponding plurality of subscribed service provider based on the user information, each one of the plurality subscriptions established between the user and the corresponding subscribed service providers;
obtaining authentication data associated with each one of the plurality of subscribed service provider;
obtaining subscription data of each one of the identified subscriptions, the subscription data including subscription cost of the identified subscription;
presenting simultaneously the subscription data of the identified subscriptions to the user through a user interface of the computer device; and
linking each one of the plurality of subscriptions and the corresponding subscribed service provider to the computer device.

2. The method of claim 1, further comprising:
generating a subscription profile for each one of the plurality of subscribed service providers, the subscription profile containing a user identity of the user, the authentication data, and the subscription data.

3. The method of claim 1, further comprising:
performing a centralized authentication process using the authentication data to authenticate the user for accessing the plurality of subscriptions linked to the computer device.

4. The method of claim 1, further comprising:
selecting one subscription from the plurality of subscriptions linked to the computer device;
monitoring a subscription status of a selected subscription, the subscription status indicating a user activity level with the selected subscription; and
in response to a determination that the user activity level is below a predetermined threshold, notifying the user of the selected subscription.

5. The method of claim 4, further comprising:
providing the user with a plurality of options for the user to select to remain, suspend, or terminate the selected subscription.

6. The method of claim 5, further comprising:
in response to a determination that no selection of the provided options is made by the user after a predetermined time elapses, automatically suspend or terminate the selected subscription for the user.

7. The method of claim 6, further comprising:
sending a notification to the user to confirm with the user that the selected subscription is suspended or terminated.

8. The method of claim 1, further comprising:
retrieving content information from each one of the plurality of subscriptions linked to the computer device;
determining, based on the content information, that the plurality of subscriptions provide overlapped content items; and
determining a redundancy level of the overlapped content items among the plurality of subscriptions.

9. The method of claim 8, further comprising:
in response to a determination that the redundancy level exceeds a predetermined level, notifying the user of the redundancy level.

10. The method of claim 9, further comprising:
prioritizing the plurality of subscriptions to generate a priority list of the plurality of subscriptions, the priority list ranking the subscriptions with lower subscription cost of redundant content items higher.

11. The method of claim 10, further comprising:
presenting the priority list to the user through the user interface; and
providing the user with an option to suspend or terminate at least one of the plurality of subscriptions holding a low position on the generated priority list.

12. The method of claim 1, further comprising:
receiving, in the computer device, a user request for a target content item; and
in response to the user request, identify a first subscription from the plurality of subscriptions linked to the computer device, the first subscription providing access to the target content item at a first subscription cost.

13. The method of claim 12, further comprising:
performing, automatically, a search to identify an unsubscribed service provider providing access to the target content item, the unsubscribed service provider being not subscribed by the user and not linked to the computer device; and
determining a second subscription cost for establishing a new subscription to the unsubscribed service provider by the user.

14. The method of claim 13, further comprising:
in response to a determination that the second subscription cost is lower than the first subscription cost, notify the user of the new subscription.

15. The method of claim 14, further comprising:
providing the user with an option for the user to establish the new subscription and suspend or terminate the first subscription.

16. A subscription hub comprising:
one or more processors; and
a computer-readable storage media storing computer-executable instructions that, when executed by the one or more processors, cause the subscription hub to:
receive, in the subscription hub, user information;
identify a plurality of subscriptions and a corresponding plurality of subscribed service provider based on the user information, each one of the plurality subscriptions established between the user and the corresponding subscribed service providers;
obtain authentication data associated with each one of the plurality of subscribed service provider;
obtain subscription data of each one of the identified subscriptions, the subscription data including subscription cost of the identified subscription;
present simultaneously the subscription data of the identified subscriptions to the user through a user interface of the subscription hub; and
link each one of the plurality of subscribed service providers to the subscription hub.

17. The subscription hub of claim 16, wherein, the instructions when executed by the one or more processors further cause the subscription hub to:
generate a subscription profile for each one of the plurality of subscribed service providers, the subscription profile containing a user identity of the user, the authentication data, and the subscription data.

18. The subscription hub of claim 16, wherein, the instructions when executed by the one or more processors further cause the subscription hub to:
perform a centralized authentication process using the authentication data to authenticate the user for accessing the plurality of subscriptions linked to the subscription hub.

19. The subscription hub of claim 16, wherein, the instructions when executed by the one or more processors further cause the subscription hub to:
select one subscription from the plurality of subscriptions linked to the subscription hub;
monitor a subscription status of a selected subscription, the subscription status indicating a user activity level with the selected subscription; and
in response to a determination that the user activity level is below a predetermined threshold, notifying the user of the selected subscription.

20. The subscription hub of claim 19, wherein, the instructions when executed by the one or more processors further cause the subscription hub to:
provide the user with a plurality of options for the user to select to remain, suspend, or terminate the selected subscription.
